(19) United States
(12) Patent Application Publication
(10) Pub. No.: US 2025/0052101 A1
(43) Pub. Date: Feb. 13, 2025

(54) ECCENTRIC PULLEY AND HARDWARE ASSEMBLY FOR CLOSING SPANS WITH GLASS PANELS

(71) Applicant: RUBENS AMERICO BRAGA, São Paulo (BR)

(72) Inventor: RUBENS AMERICO BRAGA, São Paulo (BR)

(21) Appl. No.: 18/494,325

(22) Filed: Oct. 25, 2023

(30) Foreign Application Priority Data
Aug. 9, 2023 (EP) 23020373.9

(51) Int. Cl. E05D 15/06; E05D 13/00

(52) U.S. Cl. CPC E05D 15/063; E05D 15/0634; E05Y 2600/622; E05Y 2600/624; E05Y 2600/632; E05Y 2900/132

(57) ABSTRACT

The present invention patent concerns the eccentric pulley and hardware assembly for closing spans with glass panels such as doors, boxes and room partitions. The eccentric pulley was developed with the purpose of allowing a greater amplitude of regulation during the assembly of tempered or laminated glass panels, achieving in a first version (10), a regulation range of 16 mm, that is, between −8 mm and +8 mm, and, in a second version (100), said eccentric pulley of apparent use, becomes possible to be regulated in a range of 8 mm, that is, between −4 mm and +4 mm, allowing optimization of installation and ease of assembly of the closing of spans with fastened and movable glass panels, especially with respect to the leveling adjustment of said panels in relation to the floor and walls.

### CROSS REFERENCE TO RELATED APPLICATIONS

This application claims foreign priority to European Patent Office (EP) Application No. 23020373.9 filed on Aug. 9, 2023, which is incorporated herein by reference in its entirety.

### TECHNICAL FIELD OF THE INVENTION

The present invention patent concerns the eccentric pulley and hardware assembly for closing spans with glass panels such as doors, boxes and room partitions. The eccentric pulley was developed with the purpose of allowing a greater amplitude of regulation during the assembly of tempered or laminated glass panels, reaching in a first version, an adjustment range of 16 mm, that is, between −8 mm and +8 mm, and, in a second version, said eccentric pulley of apparent use, it becomes possible to regulate 8 mm, that is, between −4 mm and +4 mm, allowing optimization of installation and ease of assembly of the closing of spans with fastened and movable glass panels, especially with respect to the leveling adjustment of said panels in relation to the floor and walls.

The hardware assembly of the eccentric pulley of apparent use of this request was designed to enable the regulation of this model of pulley, also giving a differentiated and aesthetically attractive design of the closing of spans with glass panels.

### BACKGROUND OF THE INVENTION

Eccentric pulleys are accessories assembled on the upper edge of the movable panels assisting both in the sliding of said glass panels on the upper and lower profiles, and in the adjustment of the plumb of the glasses. To this end, the conventional pulleys comprise a set of parts assembled in such a way as to compose eccentric axes that, by torquing these parts to each other, allows the adjustment of height of the panels to obtain the leveling of glass plates in relation to the floor.

The current eccentric pulleys have varied configurations, however, in general, they reach a range of regulation of 4 mm at most, that is, between −2 mm and +2 mm (6A, 6B and 6C), which in many cases is not enough to achieve a perfect fit of the panels in relation to the floor and side walls. A conventional pulley (RE) model, cited only as an example for better understanding (see FIGS. 1 and 2 of the State of the Art), is one whose basic parts—support and support cover—are made with brass parts, including the bushing, while the threaded spindle is made in stainless steel or other. Thus, added to the configurations of parts and respective materials, the conventional pulley model presents, in addition to low cost, the mechanical strength necessary to support the movable glass panel. FIGS. 1 and 2 represent, by way of example, a conventional model where the eccentric pulley (RE) comprises a caster (Rd) made of polyacetal or other similar material in whose center is poured and pierced by a threaded screw (P1) assembled on the axle (E1) that also passes through a brass support (Sp 1) and an eccentric brass bushing (Be) arranged on the axle (E2) with a distance (x) of 2 mm from the axle (E1), a bushing that is fitted in a hole (01) of the movable glass panel (PV1) and that receives the juxtaposition of thrust washer (A1). The entire assembly is fastened by nut (P3).

It happens that the distance between the axles (E1) and (E2) of the conventional eccentric pulley models generally have a distance (x) of at most 2 mm, that is, the alignment adjustment in this conventional eccentric pulley model is 4 mm, that is, −2 mm (down) or +2 mm (up) (FIGS. 6A, 6B and 6C), a fact that limits the proper adjustment of the movable glass panels (PV1), and may even, due to the structural deformations of the civil construction, not provide the necessary adjustment and make it impossible to properly level, leaving exposed spans between the glass panels and the ground and also in relation to the walls, compromising the aesthetics as well as the tightness and sealing.

In other cases, in view of the weight of the panels, it may result in small involuntary maladjustment generating drag and friction in relation to the ground and even the breakage of the movable glass panel (PV1) or the fastened panel (PV2).

Also known are other models of hardware assemblies designed to receive apparent pulleys, which are not of the eccentric type, since said pulleys of the apparent type slide on the outer portion of the upper profiles or rails and are generally fastened to the panels by means of supports with shapes in ‘C’, oblong plate or other device that, in addition to not allowing height adjustment in relation to the ground and side walls, when assembled next to the glass panels, create a visually unattractive structure, apart from a harmonized environment.

On the other hand, as will be seen below, with the present invention, the eccentric pulley of the apparent type presents itself in such a way as to be not only compatible and harmonious aesthetic look with the complementary hardware assembly, giving a more elegant and modern look to the closing of spans with glass panels, allows adjustment. This visual compatibility results in a lighter and more discreet structure, which complements the aesthetics of glass panels. Thus, the present invention is expected to offer an efficient and aesthetically pleasing solution for closing spans with glass panels.

The other components that constitute the complementary hardware of span closures by means of glass panels are the support profiles of the eccentric pulleys and also the fastening components of the support rail, the end stop and the lower slide guide of the movable glass panel. As is known, there is a wide range of models of these components, which are made, as a rule, to complete the characteristics of the supporting pulleys of the panels, in order to harmonize the assemblies.

### ANALYSIS OF THE STATE OF THE ART

In a research carried out in a specialized database, documents were found referring to eccentric pulley models and hardware assembly for closing spans with glass panels, such as document no. BR MU 8100702-7 which features an eccentric pulley equipped with a bearing for use in sliding doors and other elements consists of a sliding element equipped with an axle, intermediate body provided with front and rear fastening bushings and adjustment element equipped with a screw, and the sliding element is formed by a cylindrical body with a core and internal bearing, has a screw that allows it to be fastened to the front bushing and positioned in a displaced manner in relation to the central point of this face of the body, at the rear is positioned the rear bushing, perfectly centered, the eccentricity of the front bushing allows the sliding element to remain positioned at the front thereof and in the rail channel, the intermediate body is supported on the surface of door, the rear bushing penetrates into the hole to receive the regulating element, placed at the back of door, the screw is introduced into the hole and the rear bushing, this form of installation allows the tightening and fastening of the glass by the rear of pulley.

Document No. BR MU 8303182-0 is a typical example of conventional eccentric pulley as defined in FIGS. 1 and 2, that is, it presents an eccentric pulley with self-lubricating bearing or bushing comprising a pulley composed of a brass or similar axle coated with plastic or similar washers lining the glass fitting raceway and a self-lubricating bushing on the front of the pulley.

Document No. CN 214246999 discloses an outer double sliding door, an inner sliding door, a guide rail, and a rolling guide rail, adjustable anti-rise pulley blocks that are disposed on both sides of the top of outer sliding door, respectively, each adjustable anti-rise pulley block comprising an adjustable anti-rise hook disposed on both sides of the top of outer sliding door, respectively.

Document No. CN 103590717A features a bathroom boxing consisting of a wallbase, a base and glass doors. The glass doors include a movable door and a fastened door; a sliding band is disposed horizontally at the top of the assembly and two upper pulleys and a lower pulley are attached to the upper end of the movable door; a plastic pulley is disposed in the middle of each pulley; strips are embedded in the upper surface and the lower surface of the sliding strip; the sliding strip is located between the upper pulleys and the lower pulley; the base comprises a lower guide rail and a side rail, and the upper surface of the lower guide rail is free of sliding grooves.

Thus, it is a fact that the documents mentioned in the paragraphs above, despite belonging to the same field of application, do not present any of the characteristics of the object now improved, thus ensuring that it meets the legal requirements of patentability.

### OBJECTIVES OF INVENTION

Thus, the advantage of the eccentric pulley (10) (FIGS. 3 and 4) of the first version presented in this application consists in the fact that, conceptually, it maintains practically the same dimensions as conventional pulleys, however it enables a greater range of adjustment in relation to the usual market models since it presents a main support (10) whose projecting pin (11), which secures the caster or bearing (Rd) by means of a spindle (P1) and which is arranged on the Axle (E1), is maintained at a distance (y) of at least 16 mm in relation to the projecting pin (12) assembled on the axle (E3), which runs through the hole (O) of the movable glass panel (PV1). There is also provided a cover (13) that fits on the outside of the projecting pin (12) and is fastened to it by means of the screw (P2) and respective nut (P3). Therefore, the distance of at least 16 mm between the axles (E1) and (E3) allows the support (10) with the caster (Rd) to rotate in relation to the cover (13) supporting the movable glass panel (PV1) in a range between −8 mm to +8 mm (see FIGS. 7A, 7B and 7C) with a wheelbase of 16 mm (y), considerably increasing the possibility of adjustment and alignment of said glass panel in relation to the floor and walls.

Another advantage of the model of first eccentric pulley version lies in the fact that the support part and the support cover of the glass panel are made of engineering polymer, for example nylon with its reinforcing loads such as fiberglass, tungsten and other elements, in addition to dispensing with the intermediate insulating ring, reducing costs without, however, losing the mechanical strength in relation to the weight of glass panels, since the threaded spindles arranged longitudinally in the eccentric pulley act as mechanical reinforcing axles.

Another advantage lies in the fact that the bushing, where the caster is arranged, is made of sintered bronze that gives greater durability to the product, as well as a smoother movement, especially in environments with high humidity, especially when compared to the pulley with carbon steel bearing or with sliding systems, thus bringing a solution with real improvements for buyers who will have lower maintenance costs, as well as being able to have a quality product for much longer, in addition to having a safer movement, since it is smooth.

Another advantage consists in the fact of the oblong configuration of the support, as well as the predictability of an individualized hole intended for assembly an adjustment axle, enabling the transfer of vertical load from the caster to said axle, preventing it from being overloaded with the weight derived from the glass plates.

Another substantial advantage of the new configuration of the eccentric pulley is that it may expand its application in the glass market, such as, in addition to the traditional use in the assembly of bathroom boxes, the same, due to this range of adjustment achieved and superior mechanical strength, can be used in glazing or closures of balconies, room partitions and other applications.

The constructive variation of the eccentric pulley, developed to be of the apparent type and respective innovative hardware assembly allows, in addition to a safe and smooth sliding of the glass panels, while minimizing the amount of structuring required, allows the glass panels to be adjusted in a setting range of 8 mm (w) between the fastened axle (E1) and the eccentric axle (E4) (FIG. 9A, 9B and other figures), that is, an adjustment from −4 mm to +4 mm, also ensuring a bold and sophisticated look to the hardware assembly, providing a more pleasant and aesthetically attractive user experience.

Another innovation of the present invention refers to the model of support rail of the apparent eccentric pulley, a rail in extruded aluminum that adopts a shape of little thickness and little height, that is, visually compatible with the lightness of the hardware assembly, but, at the same time, is robust and capable of adopting varied configurations to receive the support of the eccentric pulley, with a section suitable for said support rail, in order to prevent said support of the pulley from involuntarily escaping from the rail, that is, the new model of rail ensures the safety of sliding of the apparent eccentric pulley, dispensing with conventional safety locks and accessories.

There is also provided a model of component for fastening the ends of the support profile that comprises an “L” piece to be fastened to each closing wall of the gap, which piece receives a finishing sleeve that is fastened to the “L” piece, facilitating assembly and obtaining optimal finishing.

Innovation also has a stopper for the movable glass panel that comprises a guide part with two oblong and hollow holes, one for the passage of support rail and another for the assembly of a resilient part, such as rubber or equivalent. Thus, with the “L” part properly attached to the wall, it is enough to juxtapose the guide part, already equipped with the aforementioned rail and the resilient part, allowing the movable glass panel to slide and accommodate itself easily and safely.

Complementing the hardware assembly for assembly the span closure, a lower guide for displacement of the movable glass panel is also provided, which is formed by two basic parts, one of them to be fastened to the floor and another fitted on the previous one, allowing better adjustment and positioning of this guide, facilitating the final assembly of the span closure.

### DESCRIPTION OF FIGURES

Complementing the present description in order to obtain a better understanding of the characteristics of the invention and according to a preferred practical embodiment thereof, accompanies the attached description a set of drawings, where, in an exemplary but not limiting manner, the following was represented:

FIG. 1 shows a perspective view of an eccentric pulley provided in the prior art;

FIG. 2 is a longitudinal cross-sectional view “A” of the eccentric pulley illustrated in FIG. 1, exemplifying the prior art;

FIG. 3 discloses an assembled perspective view of the innovated eccentric pulley;

FIG. 4 is a sectional view “B” with respective assembled parts;

FIG. 5 depicts a longitudinal cross-sectional view “B” indicated in FIG. 3 with the respective parts of the eccentric pulley in exploded position and with enlarged details;

FIGS. 6A, 6B and 6C show front and schematic views of the eccentric pulley of Prior Art, illustrating the short adjustment range of alignment (x) of the pulley assembled on a glass panel relative to the supporting profile (PF) of the pulley;

FIGS. 7A, 7B and 7C show front and schematic views of the innovated eccentric pulley, illustrating the possible adjustment range of alignment (y) of the innovated eccentric pulley assembled on the glass panel with respect to the profile (PF) supporting the pulley;

FIG. 8A shows an exploded perspective view of an alternative of the eccentric pulley of FIGS. 3 and 4, in particular constructive changes of the cover and the support, where tubular projection (11) of the support (10) is eliminated, being replaced by bronze bushing;

FIG. 8B depicts a side cut of the eccentric pulley of FIG. 8A with cover, bracket and bronze bushing in alternative configurations;

FIG. 9A discloses an assembled perspective view of the third variation of the eccentric pulley in the apparent and caster version in the form of a pulley;

FIG. 9B shows a side view of the preceding figure;

FIG. 9C shows an exploded perspective view of the elements comprised by the eccentric pulley of the apparent type;

FIGS. 9D and 9E depict side views of the apparent type eccentric pulley in exploded and assembled position, respectively;

FIG. 10 shows the perspective view of a movable and another fastened span closing panel revealing, in detail, the upper fastening components of the support rail, the stopper and the lower guide;

FIGS. 11a and 11b show, in greater detail, the fastening components of the support rail and respective stopper assembled on the fastened glass and on the movable glass;

FIGS. 12a and 12b show perspective and sectional view of a movable and other fastened span closing panel detailing the positioning, as well as the assembly characteristics of the lower guide;

FIG. 13A discloses the apparent type eccentric pulley assembled on the support rail;

FIGS. 13b, 13c and 13d are cross-sections of the support rail and possible constructive variations;

FIG. 14A discloses a sectional view illustrating the assembly of the movable and fastened glass panels in a first version of the support rail and corresponding safety lock assembled on the eccentric pulley of the apparent type;

FIG. 14B discloses a sectional view illustrating the assembly of the movable and fastened glass panels on a first second of the support rail and corresponding safety lock assembled on the eccentric pulley of the apparent type;

FIG. 14C discloses a sectional view illustrating the assembly of the movable and fastened glass panels on a third version of the support rail and corresponding safety lock assembled on the eccentric pulley of the apparent type;

FIG. 15A discloses an exploded perspective view of a fourth variation of the eccentric pulley with square jacket, cap and trim cap; and

FIGS. 15B and 15C show assembled perspective views of the fourth variation of the eccentric pulley.

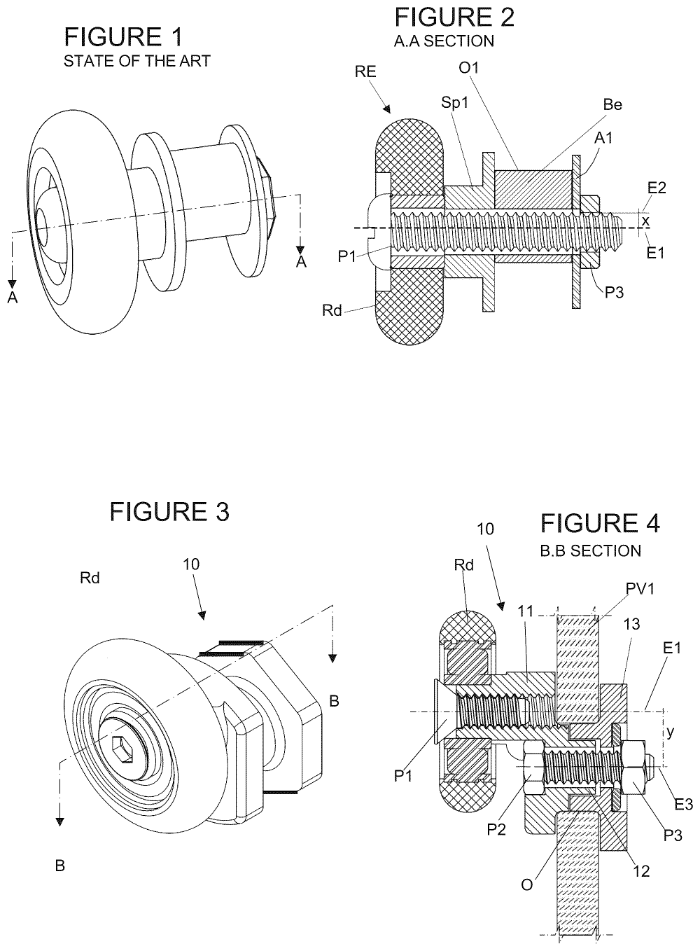

### DESCRIPTION OF THE INVENTION

The present invention patent relates to “ECCENTRIC PULLEY AND HARDWARE ASSEMBLY FOR CLOSING SPANS WITH GLASS PANELS”, eccentric pulley (10) of the type assembled on movable glass panels (PV1) of spans closing including at least one fastened glass panel (PV2); said pulley (10) including at least one caster or sliding bearing (Rd) in a fastened support rail (20) in association with a hardware assembly consisting of fastening components (30), extreme stops (40) and lower guides (50).

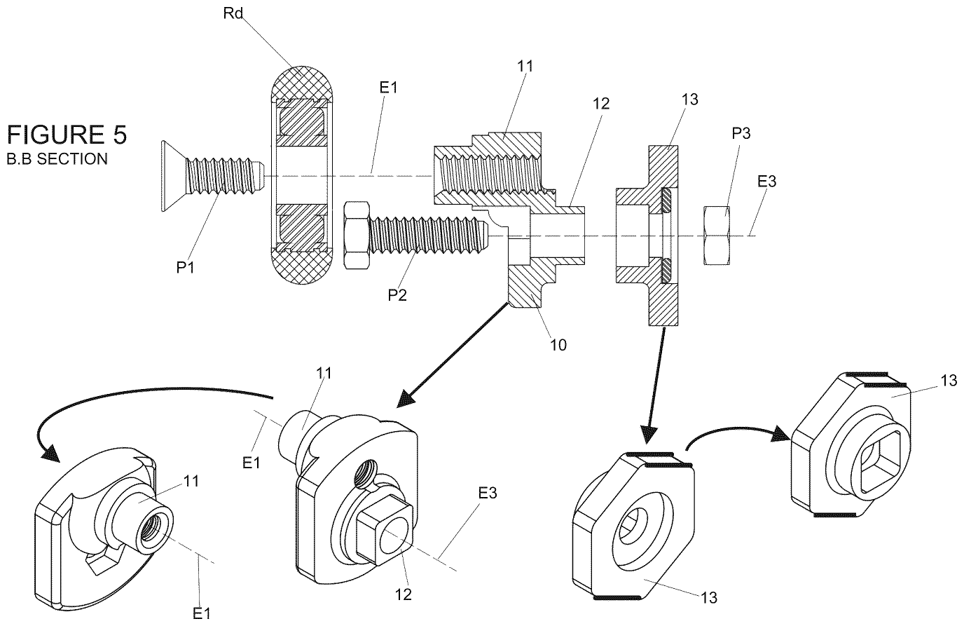

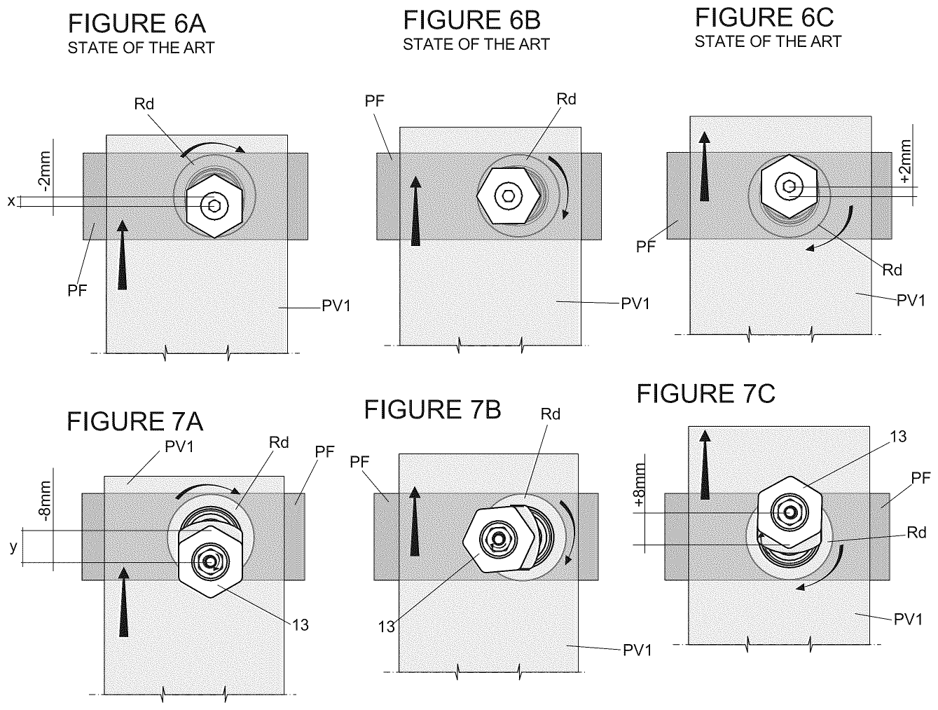

According to the present invention, the eccentric pulley (FIGS. 3, 4 and 5) comprises a main support (10) with projecting pin (11) that secures the caster or bearing (Rd) by means of a spindle (P1) and that is arranged on the Axle (E1) at a distance (y) of at least 16 mm in relation to the projecting pin (12) assembled on the axle (E3), responsible for being fitted in the hole (O) of the movable glass panel (PV1) together with a cover (13), both pin (12) and cover (13) being fastened to each other by screw (P2) and nut (P3). Thus, the distance (y) of at least 16 mm between the axes (E1) and (E3) allows the support (10) with the caster (Rd) to rotate with respect to the cover (13) supporting the movable glass panel (PV1) in a range between −8 mm to +8 mm, considerably expanding the possibility of adjustment and alignment of said movable glass panel (PV1) with respect to the floor and side walls (see FIGS. 7A, 7B and 7C).

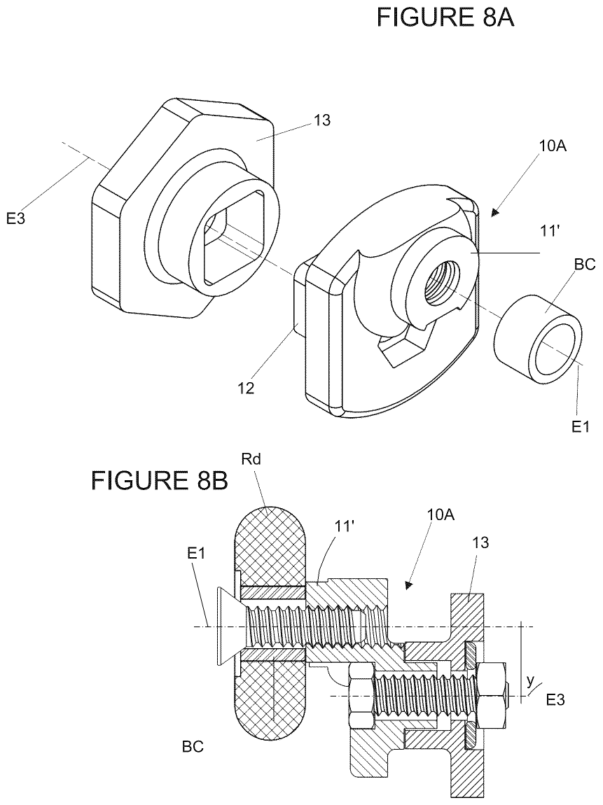

In a second version (FIGS. 8A and 8B), the support part (10A) presents the short eccentric orthogonal projection (11′) that acts as the backrest of a bronze bushing (BC) centered on the bearing or caster (Rd).

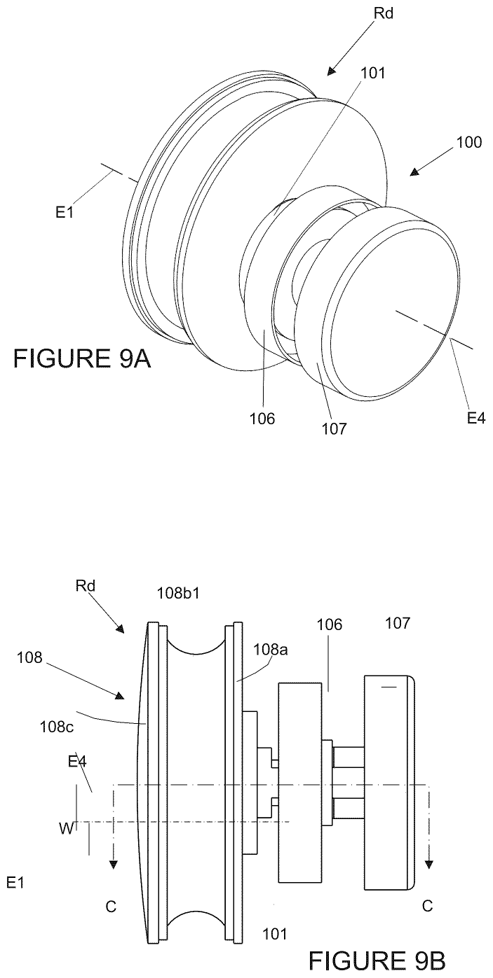

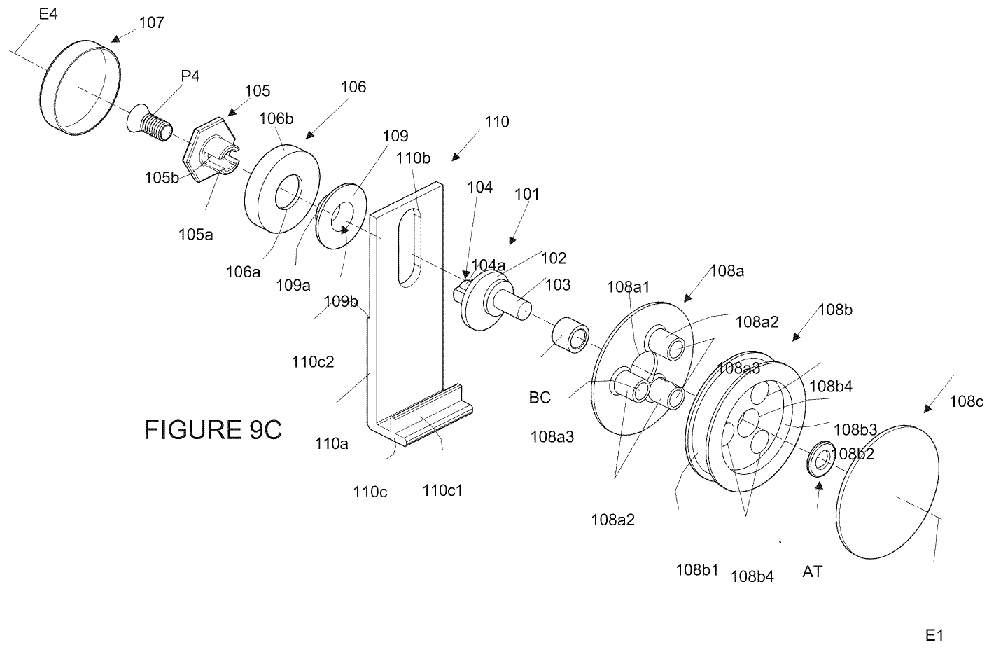

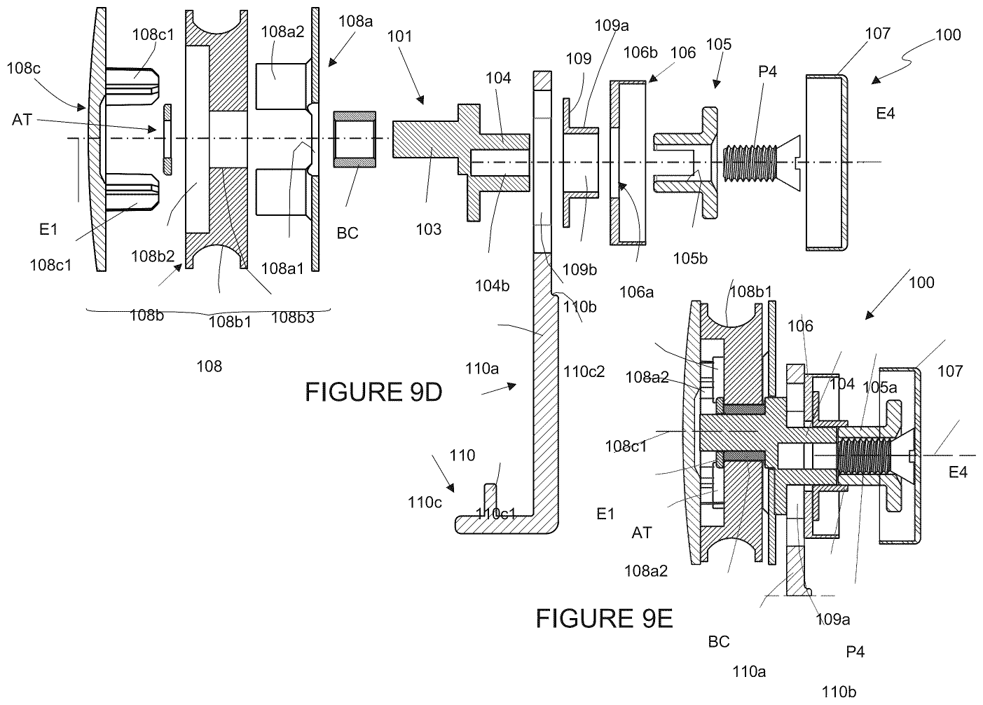

In a third variation the eccentric pulley (100) is of the apparent type with respect to the hardware assembly and with respect to the glass panels (PV1) (FIGS. 9A to 9E). More precisely, the apparent eccentric pulley (100) comprises a single body (101) in the form of a central disc (102) and has, on one of the faces, an eccentric and orthogonal solid pin (103) located on the axle (E1), while on the opposite face is another orthogonal projection (104) ordinarily cylindrical and located on the axle (E4), equipped with symmetrical and opposite recesses (104a) and providing for a threaded hole (104b); the recesses (104a) receive the fitting of a spring latch (105a) projecting a complementary disc (105) equipped with a hollow hole (105b) for overpassing a screw (P4), the thread of which is fastened in the threaded hole (104b) of the orthogonal projection (104); the spring lock (105a) enters the channel (109b) of the tubular projection (109a) developed from the circular base (109) that remains in contact with the step face (110c2) of the guide laminar part (110). The complementary disc (105) is housed within a trim cover (106) formed by disc base with central hole (106a) and flap (106b) parallel to a trim cover (107).

On the solid eccentric pin (103) is assembled the caster, comprising a pulley (108), divided into three parts, being a cover (108a) with central hole (108a1) for accommodation of a bronze bushing (BC) and at least three tubular projections (108a2) distributed radially with respect to the hole (108a1), each projection (108a2) being provided with hole (108a3) for corresponding fitting of pins (108c1) projecting from the inner face of the opposite cover (108c). Between the covers (108a)/(108c) is provided bearing (108b) with sliding channel (108b1), circular recess (108b2) (FIG. 9D) equipped with a central hole (108b3) for the passage of the solid eccentric pin (103) with respective bushing (BC) and radial holes (108b4). The other side of the circular base (109) is juxtaposed to a vertical branch (110a) of a guide laminar piece (110) in “L” that includes an oblong hole (110b), a lower base branch (110c) with projecting guide (110c1) and opposite the step (110c2). This entire assembly (108/BC/110) is locked on the eccentric solid pin (103) by means of a lock ring (AT).

The distance (w) between the axles (E1) and (E4) is 8 mm, allowing the adjustment of the movable glass panel (PV1) in relation to the floor in an adjustment range between −4 mm and +4 mm.

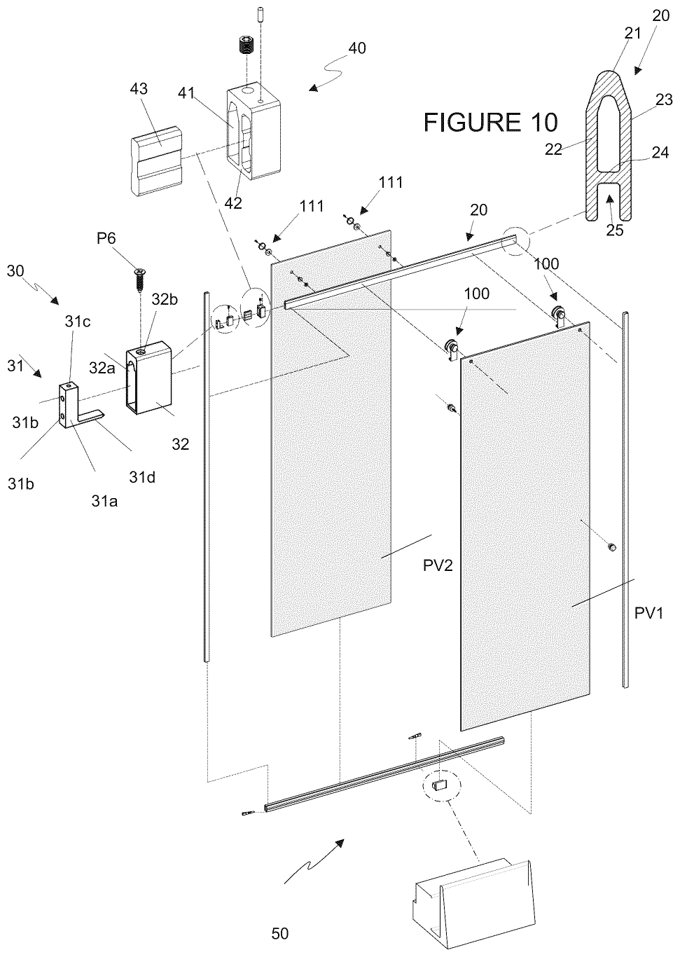

The support rail (20) of the present invention serves both for assembly the movable glass panel (PV1) and the fastened glass panel (PV2) (FIG. 10). To this end, the support rail is an aluminum extruded part to the ordinary shape of a centrally cast rectangle, comprising a tapered and rounded upper base (21) capable of accommodating the channel (108b1) of the pulley (108), as well as providing a wall (22) for fastening the assembly hardware (111) of the fastened glass panel (PV1), while the opposite wall (23) of the rail (20) is free and both (22/23) are joined in the lower portion by a base (24), comprising an inverted “U” section comprising a longitudinal channel (25) capable of receiving at least one protruding pin or guide (110c1) from the horizontal branch (110c) of the guide laminar part (110) of the apparent type eccentric pulley (100).

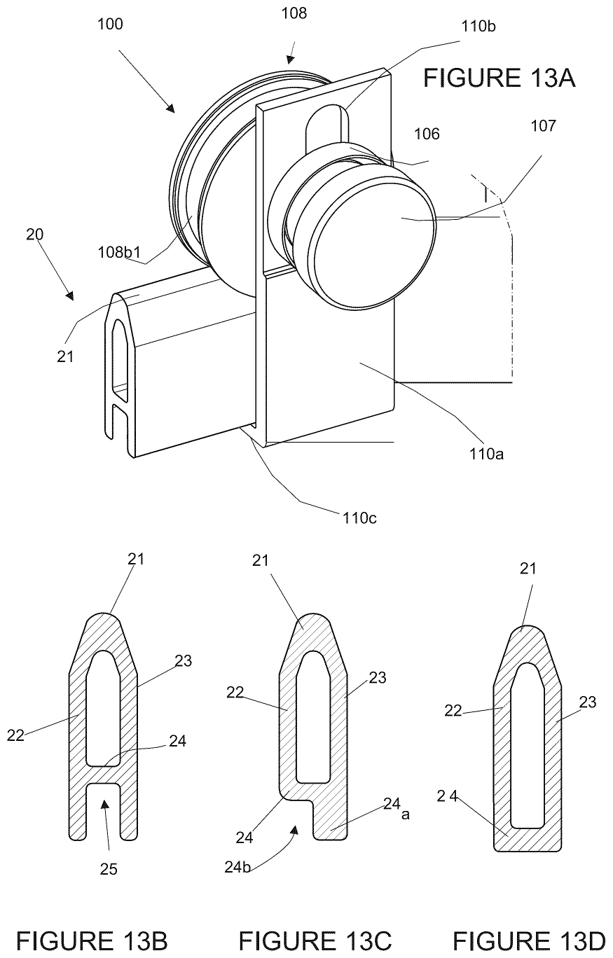

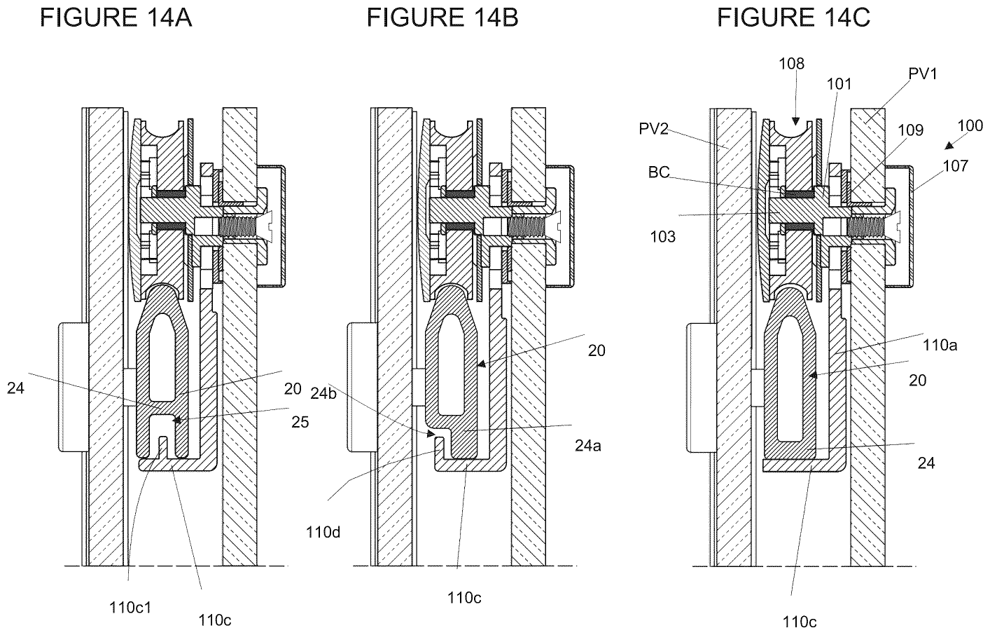

In an alternative embodiment of the support rail (20) (FIG. 13c) the lower base (24) presents a projecting tooth (24a) forming a recess (24b) that accommodates in the fold (110d) of the horizontal branch (110c) of the guide laminar piece (110).

In another alternative embodiment of the support rail (20) (FIG. 13d), the base (24) is flat and capable of being supported on a smooth horizontal branch (110c) of the guide laminar part (110).

One of the complementary hardware of the support rail assembly (20) is the assembly and fastening component (30) of the rail next to the walls.

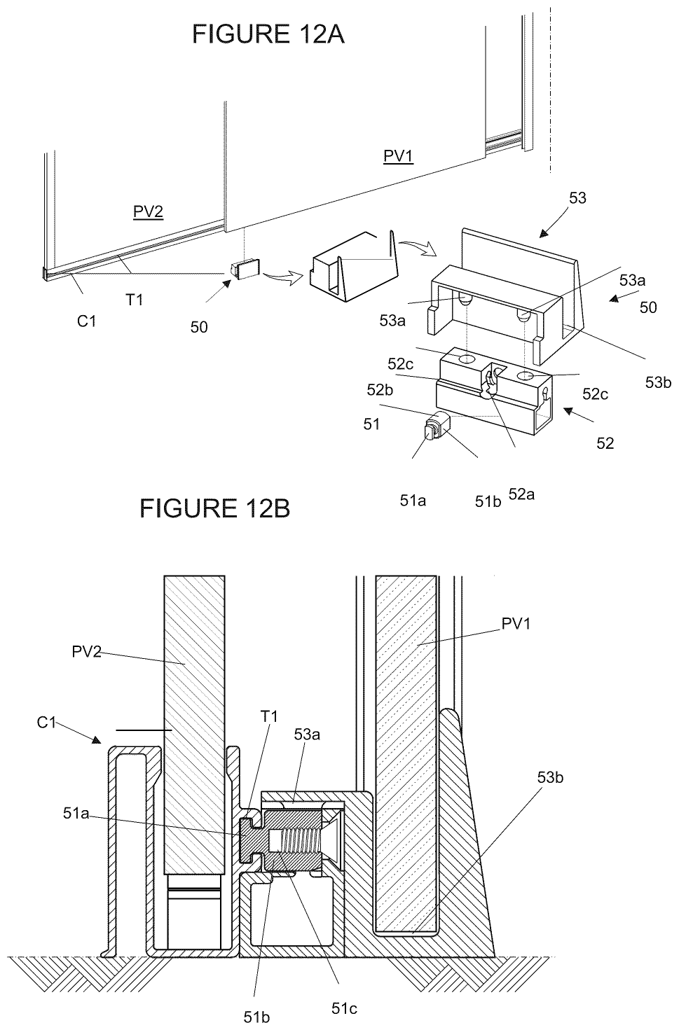

To this end, the fastening component (30) is formed by two parts (FIGS. 10, 12A and 12B) being an “L” piece (31), where the branch (31a) is of square section and provided with at least one hollow hole (31b) for passing screw (P5) fastening next to the wall and at least one threaded hole (31c) practiced at the top of said branch (31a). The branch (31d) comprises a short blade that serves as a support for the lower base (24) of the support rail (20). Said “L” part has a dimension to be fitted fairly in the housing (32a) of the trim part (32) which, in turn, has a hole (32b) in the upper base for the overpass of the fastening screw (P6).

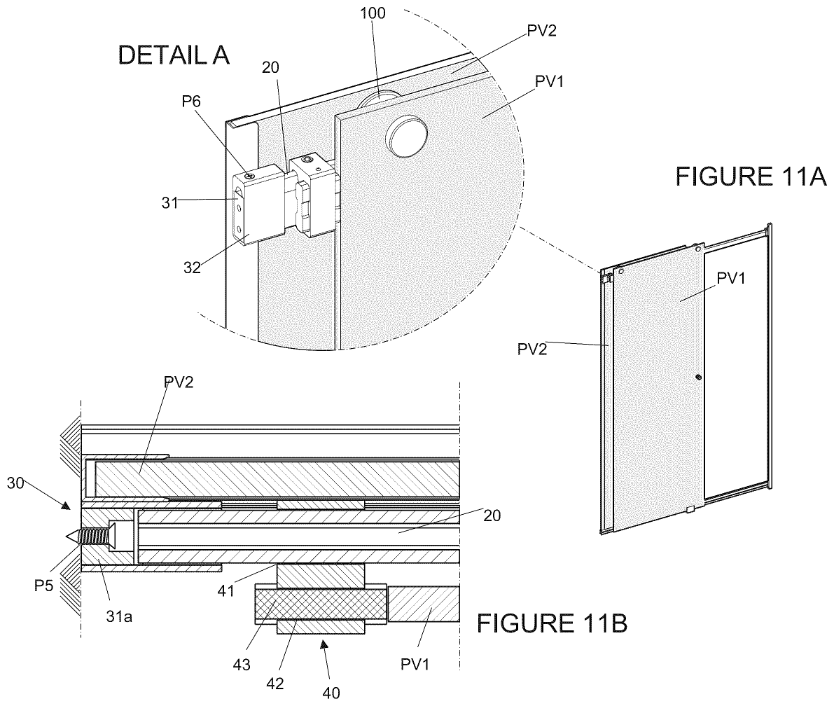

It is further envisaged a stopper (40) (FIG. 10 and detail A of FIG. 11A and FIG. 11B) for the glass movable panel (PV1) comprising an ordinarily parallelepipedal guidepiece with two oblong and hollow holes, one hole (41) for the passage of the support rail (20) and another hole (42) for the assembly of a resilient part (43), such as rubber or equivalent.

Complementing the hardware assembly for assembly the span closure, a lower guide (50) is also provided (FIGS. 12A and 12b) for displacement of the movable glass panel (PV1), which is formed by three parts, being a key (51), preferably metallic, which has an oblong head (51a) capable of fitting and adjusting the positioning of the lower guide (50) on the side rail (T1) of the lower frame (C1). Said key (51) also has a quadrangular body (51b) with a threaded hole (51c) capable of sitting in a recess (52a) practiced in the center of the fastening bearing (52), ordinarily parallelepipedal and equipped with a channel (52b) for juxtaposition next to the outer face of the rail (T1) of the frame (C1). The upper face of the bearing (52) provides at least two holes (52c) that act as a seating guide for corresponding pins (53a) of the guide (53) with a “U” section (53b) for accommodating the lower end of the glass movable panel (PV1).

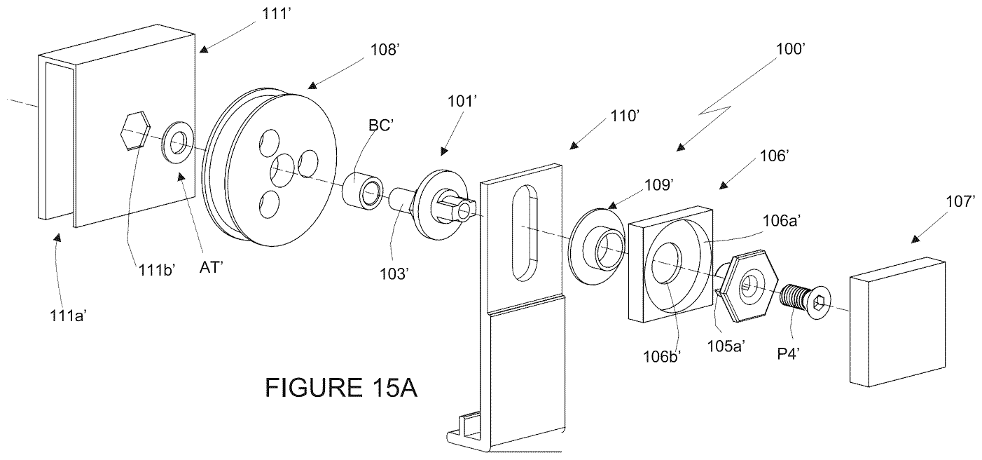

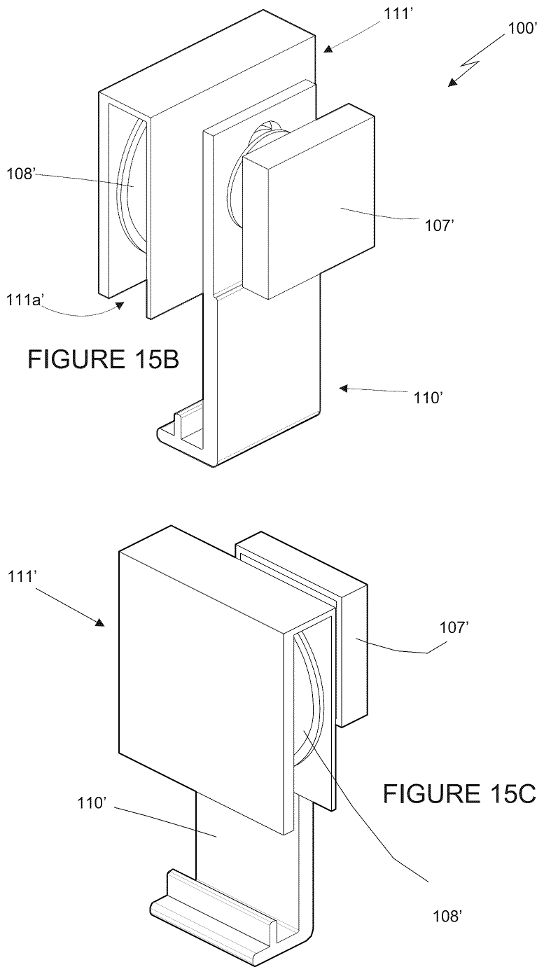

In a fourth variation (see FIGS. 15A, 15B and 15C), the eccentric pulley (100′) provides, by way of example, but not limited to said shape, a finish cover (106′) and a square finish cover (107′), the cover (106′) being provided with an annular step (106a′) with a central hole (106b′) for spring lock accommodation (105a′) with a screw (P4′), as well as a shell (111′) with an ordinarily rectangular body of a rotated ‘U’ cross-section, in which it provides access (111a′) for assembly the pulley (108′), fastened by means of the hexagonal hole (111b′) of the shell (111′) in which it receives the lock ring (AT′), an eccentric and orthogonal cross-section (103′) of single body (101′) with respective bushing (BC′) fasted in the guide laminar piece (100′) that also faster the circular base (109′).

It is true that when the present invention is put into practice, modifications maybe introduced with regard to certain details of construction and form, without this implying departing from the fundamental principles that are clearly substantiated in the claims, thus being understood that the terminology employed was not for the purpose of limitation.

1. “ECCENTRIC PULLEY AND HARDWARE ASSEMBLY FOR CLOSING SPANS WITH GLASS PANELS”, eccentric pulley (10) of the type assembled on movable glass panels (PV1) for closing spans including at least one fastened glass panel (PV2); said pulley or main support (10) with projecting pin (11) for fastening the caster or bearing (Rd) by means of spindle (P1) and which is arranged on the axle (E1) including at least one caster or bearing (Rd) and a locking cover (13) for assembly the movable spindle panel glass (PV1) sliding on fastened support rail (20) in association with a hardware assembly composed of fastening components (30), extreme stops (40) and lower guides (50); characterized by an eccentric pulley comprising projecting pin (12) assembled on the axle (E3) and fastened to the cover (13) by screw (P2) and nut (P3); the distance between the axles (E1) and (E3) is at least 16 mm; the rotation of caster (Rd) in relation to the cover (13) supporting the movable glass panel (PV1) occurs in a range between −8 mm to +8 mm in relation to the floor and side walls; the support rail (20) constitutes the assembly structure of the fastened glass panel (PV2) by means of fastening hardware (111) and simultaneously constitutes a means of displacement of the eccentric pulley (10) or of the apparent type (100); said support rail (20) with ends fitted to the part and finish (32) fastened to the “L” part (31) and also passes through the hole (41) of the stop (40) also equipped with a resilient part (43).

2. “ECCENTRIC PULLEY” according to claim 1 and a constructive option, characterized in that the support part (10A) presents the short eccentric orthogonal projection (11′) that acts as a backrest of a bronze bushing (BC) centered on the bearing or caster (Rd).

3. “ECCENTRIC PULLEY” according to claim 1 and a constructive option for eccentric pulley (100) to be of the apparent type with respect to the hardware assembly and with respect to the glass panels (PV1), characterized in that the apparent eccentric pulley (100) comprises a single body (101) in the form of a central disc (102) and has, on one side, an eccentric and orthogonal solid pin (103) located on the axle (E1), while on the opposite side is another orthogonal projection (104) ordinarily cylindrical and located on the axle (E4), equipped with symmetrical and opposite recesses (104a) and providing a threaded hole (104b); the recesses (104a) receiving the fitting of a spring lock (105a) projecting a complementary disc (105) equipped with a hollow hole (105b) for passing a screw (P4), whose thread is fastened in the threaded hole (104b) of the orthogonal projection (104); the spring lock (105a) enters the channel (109b) of the tubular projection (109a) developed from the circular base (109) that remains in contact with the step face (110c2) of the guide laminar part (110); the complementary disc (105) is housed inside a finishing cap (106) formed by discoid base with central hole (106a) and tab (106b) parallel to a finishing cap (107); on the eccentric solid pin (103) is assembled the caster, comprising a pulley (108) divided into three pieces, being a cover (108a) with a central hole (108a1) for accommodation of a bronze bushing (BC) and at least three tubular projections (108a2) distributed radially in relation to the hole (108a1), each projection (108a2) being provided with a hole (108a3) for corresponding fitting of pins (108c1) projecting from the inner face of the opposite cover (108c); between the covers (108a)/(108c) is provided bearing (108b) with sliding channel (108b1), circular recess (108b2) provided with a central hole (108b3) for passage of the eccentric solid pin (103) with respective bushing (BC) and radial holes (108b4); the other face of circular base (109) is juxtaposed to vertical branch (110a) of a guide laminar piece (110) in “L” that includes an oblong hole (110b) and a lower base branch (110c) with a projecting guide (110c1) and opposed to step (110c2); all this assembly (108/BC/110) is locked in the eccentric solid pin (103) through a lock ring (AT).

4. “ECCENTRIC PULLEY” according to claim 3, characterized in that the distance (w) between the axes (E1) and (E4) is 8 mm, allowing the adjustment of the movable glass panel (PV1) in relation to the floor in an adjustment range between −4 mm and +4 mm.

5. “HARDWARE FOR CLOSING SPANS WITH GLASS PANELS”, according to claim 1, characterized in that the support rail (20) has the ordinary shape of a centrally hollow rectangle, comprising a tapered and rounded upper base (21), as well as providing a wall (22) for fastening the assembly hardware (111) of the fastened glass panel (PV1); the opposite wall (23) is parallel to the wall (22) and joined in the lower part by a base (24) comprising an inverted “U” section comprising a longitudinal channel (25) that receives at least one projecting pin or guide (110c1) from the horizontal branch (110c) of the guide laminar part (110).

6. “HARDWARE FOR CLOSING SPANS WITH GLASS PANELS”, according to any of claims 1 and 4, characterized in that the lower base (24) of the support rail (20) can present a projecting tooth (24a) forming a fold juxtaposition (110d) recess (24b) of the horizontal branch (101c) of the guide laminar part (110).

7. “HARDWARE FOR CLOSING SPANS WITH GLASS PANELS”, according to any of claims 1 and 4, characterized in that the lower base (24) of the support rail (20) be flat for support over flat horizontal branch (110c) of the guide laminar part (110).

8. “HARDWARE FOR CLOSING SPANS WITH GLASS PANELS”, according to claim 1, characterized in that the fastening component (30) is formed an “L” piece (31), where the branch (31a) is of square section and provided with at least one hollow hole (31b) for screw passage (P5) and at least one threaded hole (31c) practiced at the top of said branch (31a); the branch (31d) comprises a short support blade of the lower base (24) of the support rail (20); said “L” part is fitted justly in housing (32a) of the trim part (32) which, in turn, has hole (32b) in the upper base for the overpass of fastening screw (P6).

9. “HARDWARE FOR CLOSING SPANS WITH GLASS PANELS” according to claim 1, characterized in that the stopper (40) comprises an ordinarily parallelepipedal guidepiece with two oblong and hollow holes, being one hole (41a) for crossing the support rail (20) and another hole (42) assembling a resilient part (43), such as rubber or equivalent.

10. “HARDWARE FOR CLOSING SPANS WITH GLASS PANELS” according to claim 1, characterized in that the lower guide (50) is formed by three parts, being a key (51), preferably metallic, with oblong head (51a) engageable in side rail (T1) of the lower frame (C1); said key (51) also has a quadrangular body (51b) with a threaded hole (51c) capable of seating in the recess (52a) practiced in the center of the fastening bearing (52), ordinarily parallelepipedal and equipped with a channel (52b) for juxtaposition next to the outer face of the rail (T1) of the frame (C1); the upper face of the bearing (52) provides for at least two holes (52c) that act as a seating guide of corresponding pins (53b) of the guide (53b) with “U” section (53v) for housing the lower end of mobile glass panel (PV1).

11. “ECCENTRIC PULLEY” according to claim 1 in another constructive option, characterized by an eccentric pulley (100′) providing a square trim cover (106′) and trim cover (107′), the cover (106′) being equipped with an annular step (106a′) with a central hole (106b′) for spring-lock accommodation (105a′) with a screw (P4′), as well as also providing a shell (111′) with an ordinarily rectangular body of rotated ‘U’ cross-section, in which it has access (111a′) for pulley assembly (108′), fastened by means of the hexagonal hole (111b′) of the shell (111′) in which it receives a lock ring (AT), a solid and orthogonal pin (103′) of the single body (101′) with respective bushing (BC′), fastened to the guide laminar part (110′) which also fasten circular base (109′).
